(19) United States
(12) Patent Application Publication
(10) Pub. No.: US 2023/0254759 A1
(43) Pub. Date: Aug. 10, 2023

(54) ADMISSION CONTROL OF NODES DEPENDING ON MOBILITY STATUS

(71) Applicant: QUALCOMM Incorporated, San Diego, CA (US)

(72) Inventors: Naeem AKL, Somerville, NJ (US); Navid ABEDINI, Basking Ridge, NJ (US); Karl Georg HAMPEL, Jersey City, NJ (US); Jianghong LUO, Skillman, NJ (US); Junyi LI, Fairless Hills, PA (US); Tao LUO, San Diego, CA (US)

(21) Appl. No.: 17/650,022

(22) Filed: Feb. 4, 2022

(51) Int. Cl. H04W 48/04; H04W 8/02

(52) U.S. Cl. CPC H04W 48/04; H04W 8/02

(57) ABSTRACT

Various aspects of the present disclosure generally relate to wireless communication. In some aspects, a distributed unit (DU) of an integrated access and backhaul (IAB) node may receive, from a centralized unit (CU) of an IAB donor, an indication of a mobility state of a child node of the DU. The DU may perform an admission control for the child node based at least in part on the mobility state of the child node. Numerous other aspects are described.

### FIELD OF THE DISCLOSURE

Aspects of the present disclosure generally relate to wireless communication and to techniques and apparatuses for admission control of nodes depending on mobility status.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus of a distributed unit (DU) of an integrated access and backhaul (IAB) node for wireless communication includes a memory; and one or more processors coupled to the memory, wherein the memory includes instructions executable by the one or more processors to cause the DU of the IAB node to: receive, from a centralized unit (CU) of an IAB donor, an indication of a mobility state of a child node of the DU; and perform an admission control for the child node based at least in part on the mobility state of the child node.

In some implementations, an apparatus of a CU of an IAB donor for wireless communication includes a memory; and one or more processors coupled to the memory, wherein the memory includes instructions executable by the one or more processors to cause the CU of the IAB donor to: transmit, to a DU of an IAB node, an indication of a mobility state of a child node of the DU; and receive, from the DU, an indication of an admission control that indicates whether the DU admits the child node.

In some implementations, a method of wireless communication performed by a DU of an IAB node includes receiving, from a CU of an IAB donor, an indication of a mobility state of a child node of the DU; and performing an admission control for the child node based at least in part on the mobility state of the child node.

In some implementations, a method of wireless communication performed by a CU of an IAB donor includes transmitting, to a DU of an IAB node, an indication of a mobility state of a child node of the DU; and receiving, from the DU, an indication of an admission control that indicates whether the DU admits the child node.

In some implementations, a non-transitory computer-readable medium storing a set of instructions for wireless communication includes one or more instructions that, when executed by one or more processors of a DU of an IAB node, cause the DU of the IAB node to: receive, from a CU of an IAB donor, an indication of a mobility state of a child node of the DU; and perform an admission control for the child node based at least in part on the mobility state of the child node.

In some implementations, a non-transitory computer-readable medium storing a set of instructions for wireless communication includes one or more instructions that, when executed by one or more processors of a CU of an IAB donor, cause the CU of the IAB donor to: transmit, to a DU of an IAB node, an indication of a mobility state of a child node of the DU; and receive, from the DU, an indication of an admission control that indicates whether the DU admits the child node.

In some implementations, an apparatus for wireless communication includes means for receiving, from a CU of an IAB donor, an indication of a mobility state of a child node of the apparatus; and means for performing an admission control for the child node based at least in part on the mobility state of the child node.

In some implementations, an apparatus for wireless communication includes means for transmitting, to a DU of an IAB node, an indication of a mobility state of a child node of the DU; and means for receiving, from the DU, an indication of an admission control that indicates whether the DU admits the child node.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of radio access networks, in accordance with the present disclosure.

FIG. 4 is a diagram illustrating an example of an integrated access and backhaul (IAB) network architecture, in accordance with the present disclosure.

FIG. 5 is a diagram illustrating an example of admission control, in accordance with the present disclosure.

FIG. 6 is a diagram illustrating an example associated with admission control of nodes depending on mobility status, in accordance with the present disclosure.

FIGS. 7-8 are diagrams illustrating example processes associated with admission control of nodes depending on mobility status, in accordance with the present disclosure.

FIGS. 9-10 are diagrams of example apparatuses for wireless communication, in accordance with the present disclosure.

FIG. 11 is a diagram illustrating an example disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

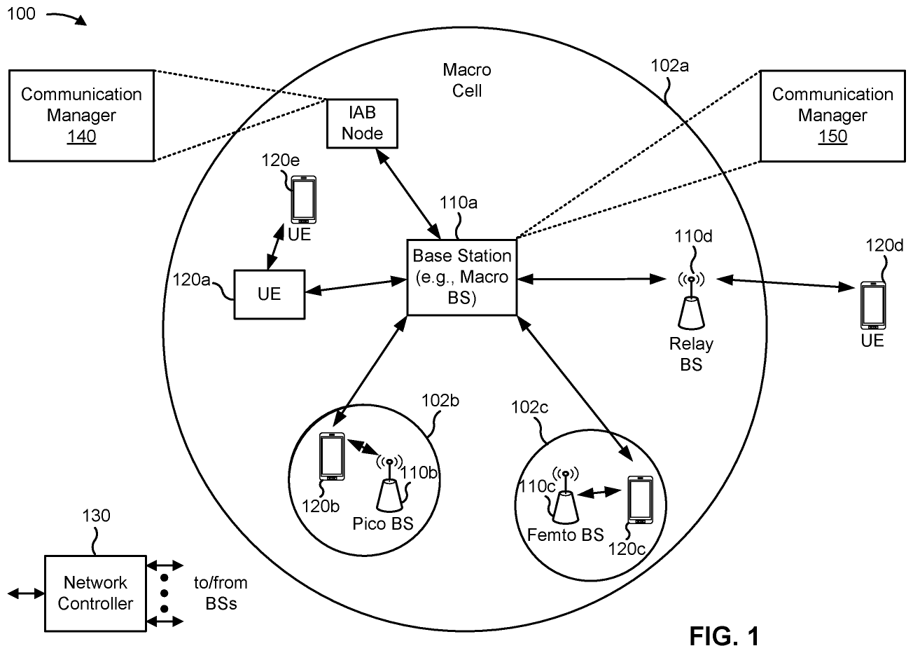

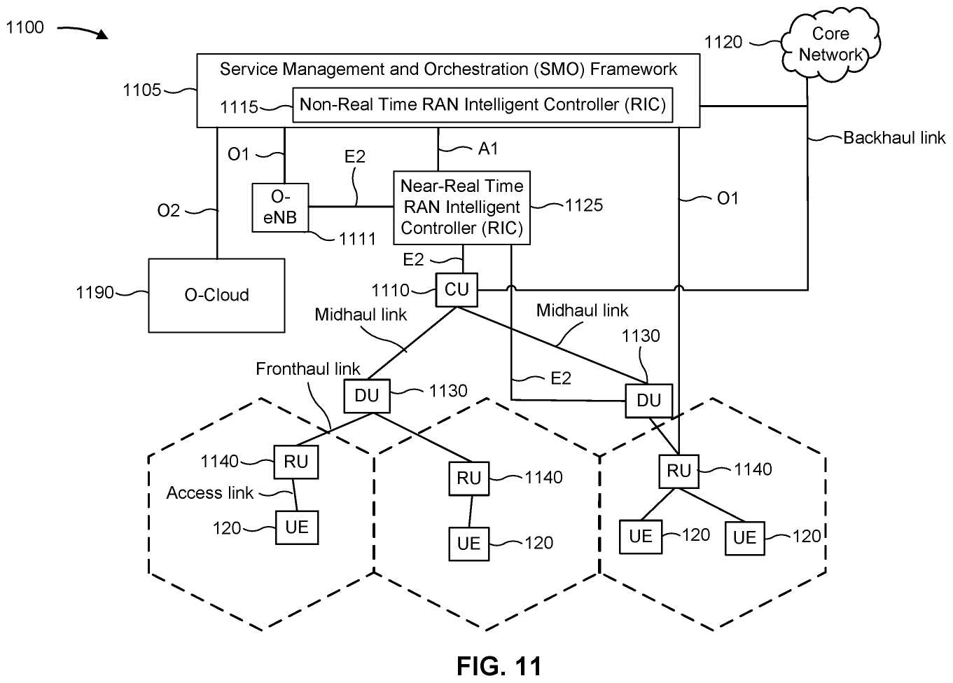

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although depicted as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 11. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

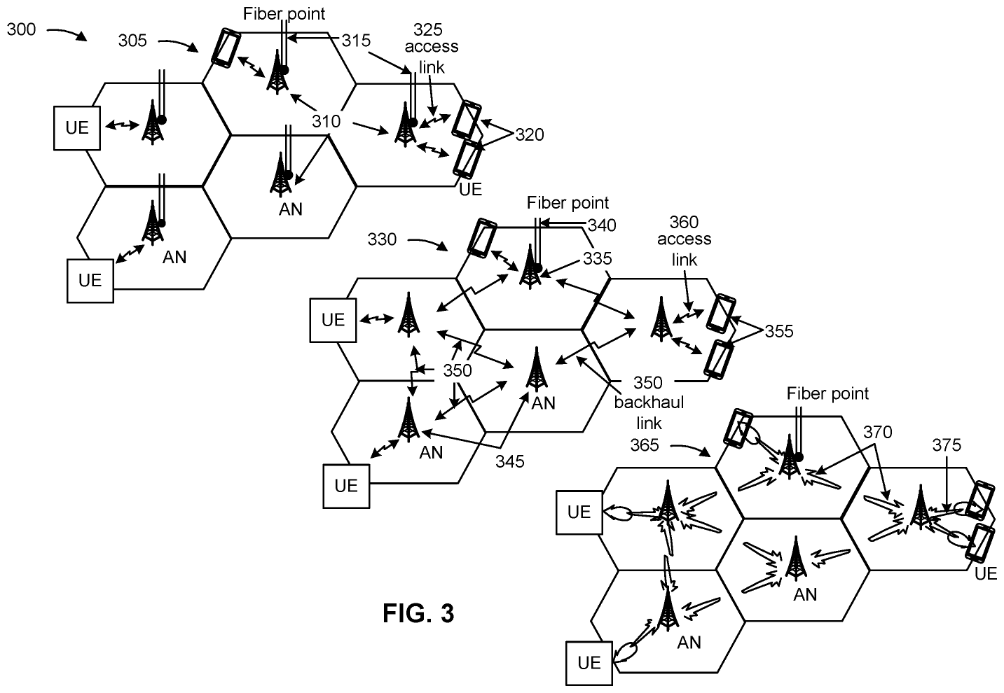

In some aspects, a distributed unit (DU) of an integrated access and backhaul (TAB) node (as shown in FIGS. 3, 4, and 6) may include a communication manager 140. As described in more detail elsewhere herein, the communication manager 140 may receive, from a centralized unit (CU) of an IAB donor, an indication of a mobility state of a child node of the DU; and perform an admission control for the child node based at least in part on the mobility state of the child node. Additionally, or alternatively, the communication manager 140 may perform one or more other operations described herein.

In some aspects, a CU of an IAB donor (as shown in FIGS. 3, 4, and 6) may include a communication manager 150. As described in more detail elsewhere herein, the communication manager 150 may transmit, to a DU of an TAB node, an indication of a mobility state of a child node of the DU; and receive, from the DU, an indication of an admission control that indicates whether the DU admits the child node. Additionally, or alternatively, the communication manager 150 may perform one or more other operations described herein.

As indicated above, FIG. 1 is provided as an example. Other examples may differ from what is described with regard to FIG. 1.

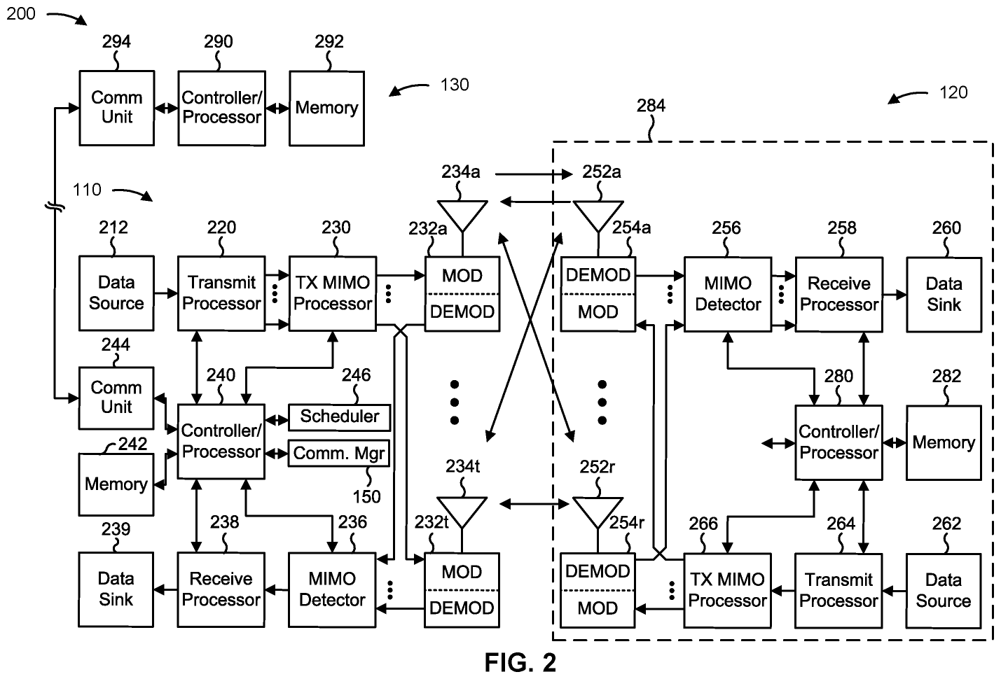

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

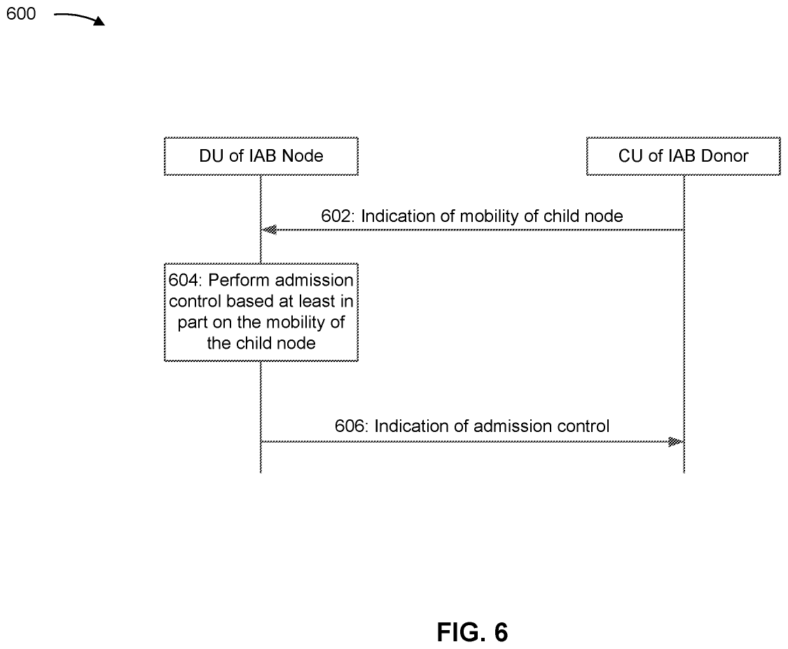

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

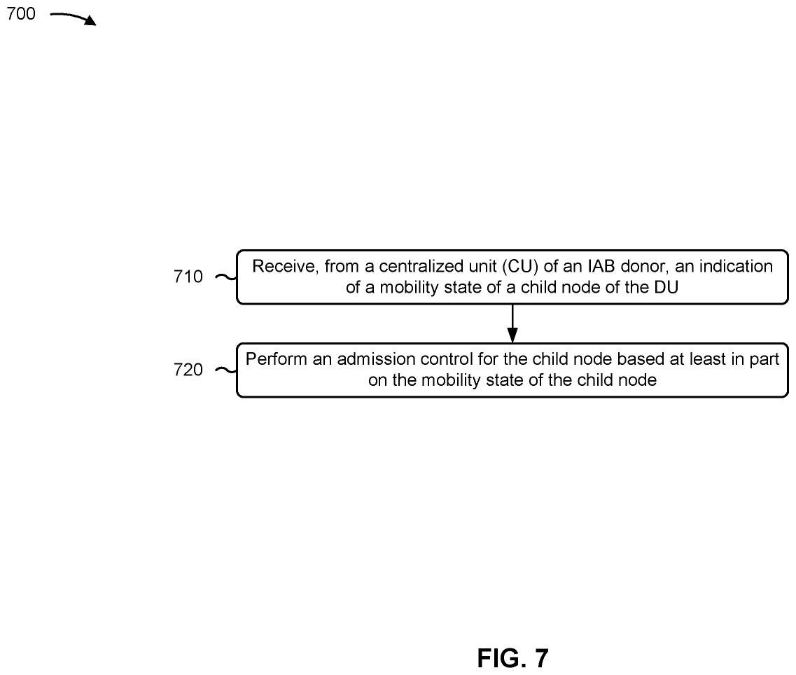

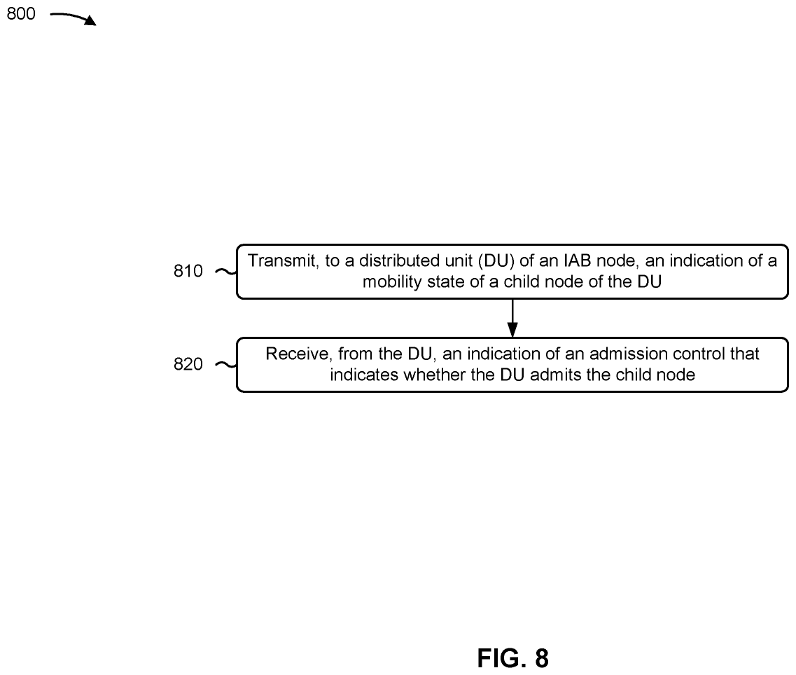

The controller/processor 240 of the base station 110, the controller/processor 280 of the UE 120, and/or any other component(s) of FIG. 2 may perform one or more techniques associated with admission control of nodes depending on mobility status, as described in more detail elsewhere herein. In some aspects, the IAB node and/or the IAB donor described herein is the base station 110, is included in the base station 110, or includes one or more components of the base station 110 shown in FIG. 2. In some aspects, the child node described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a DU of an IAB node (as shown in FIGS. 3, 4, and 6) includes means for receiving, from a CU of an IAB donor, an indication of a mobility state of a child node of the DU; and/or means for performing an admission control for the child node based at least in part on the mobility state of the child node. In some aspects, the means for the DU of the IAB node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a CU of an IAB donor (as shown in FIGS. 3, 4, and 6) includes means for transmitting, to a DU of an IAB node, an indication of a mobility state of a child node of the DU; and/or means for receiving, from the DU, an indication of an admission control that indicates whether the DU admits the child node. In some aspects, the means for the CU of the IAB donor to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating examples 300 of radio access networks, in accordance with the present disclosure.

As shown by reference number 305, a traditional (e.g., 3G, 4G, or LTE) radio access network may include multiple base stations 310 (e.g., access nodes (AN)), where each base station 310 communicates with a core network via a wired backhaul link 315, such as a fiber connection. A base station 310 may communicate with a UE 320 via an access link 325, which may be a wireless link. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a radio access network may include a wireless backhaul network, sometimes referred to as an IAB network. In an IAB network, at least one base station is an anchor base station 335 that communicates with a core network via a wired backhaul link 340, such as a fiber connection. An anchor base station 335 may also be referred to as an IAB donor (or IAB-donor). The IAB network may include one or more non-anchor base stations 345, sometimes referred to as relay base stations or IAB nodes (or IAB-nodes). The non-anchor base station 345 may communicate directly or indirectly with the anchor base station 335 via one or more backhaul links 350 (e.g., via one or more non-anchor base stations 345) to form a backhaul path to the core network for carrying backhaul traffic. Backhaul link 350 may be a wireless link. Anchor base station(s) 335 and/or non-anchor base station(s) 345 may communicate with one or more UEs 355 via access links 360, which may be wireless links for carrying access traffic. In some aspects, an anchor base station 335 and/or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a radio access network that includes an IAB network may utilize millimeter wave technology and/or directional communications (e.g., beamforming) for communications between base stations and/or UEs (e.g., between two base stations, between two UEs, and/or between a base station and a UE). For example, wireless backhaul links 370 between base stations may use millimeter wave signals to carry information and/or may be directed toward a target base station using beamforming. Similarly, the wireless access links 375 between a UE and a base station may use millimeter wave signals and/or may be directed toward a target wireless node (e.g., a UE and/or a base station). In this way, inter-link interference may be reduced.

The configuration of base stations and UEs in FIG. 3 is shown as an example, and other examples are contemplated. For example, one or more base stations illustrated in FIG. 3 may be replaced by one or more UEs that communicate via a UE-to-UE access network (e.g., a peer-to-peer network or a device-to-device network). In this case, an anchor node may refer to a UE that is directly in communication with a base station (e.g., an anchor base station or a non-anchor base station).

As indicated above, FIG. 3 is provided as an example. Other examples may differ from what is described with regard to FIG. 3.

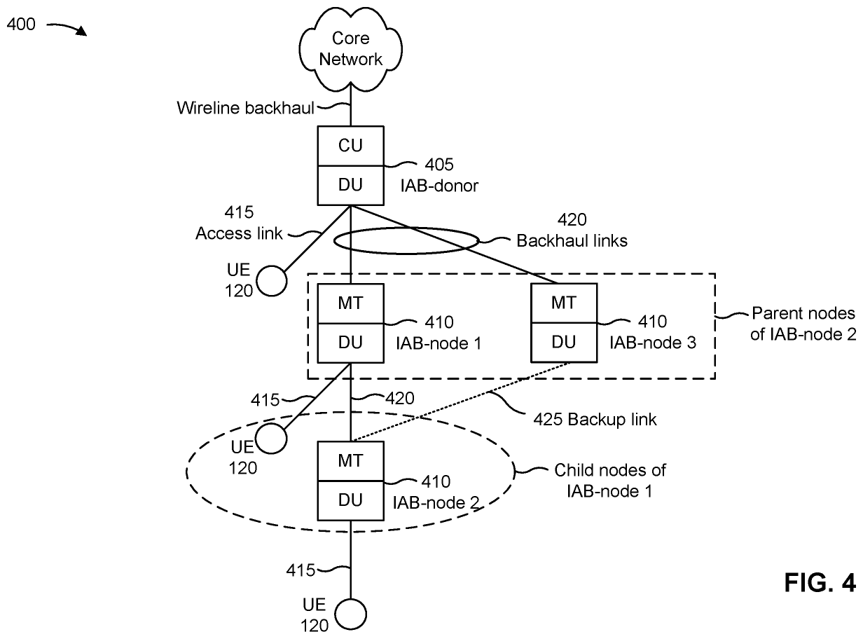

FIG. 4 is a diagram illustrating an example 400 of an IAB network architecture, in accordance with the present disclosure.

As shown in FIG. 4, an IAB network may include an IAB donor 405 (shown as IAB-donor) that connects to a core network via a wired connection (shown as a wireline backhaul). For example, an Ng interface of an IAB donor 405 may terminate at a core network. Additionally, or alternatively, an IAB donor 405 may connect to one or more devices of the core network that provide a core access and mobility management function (AMF). In some aspects, an IAB donor 405 may include a base station 110, such as an anchor base station, as described above in connection with 3. As shown, an IAB donor 405 may include a CU, which may perform access node controller (ANC) functions and/or AMF functions. The CU may configure a DU of the IAB donor 405 and/or may configure one or more IAB nodes 410 (e.g., a mobile termination (MT) and/or a DU of an IAB node 410) that connect to the core network via the IAB donor 405. Thus, a CU of an IAB donor 405 may control and/or configure the entire IAB network that connects to the core network via the IAB donor 405, such as by using control messages and/or configuration messages (e.g., a radio resource control (RRC) configuration message or an F1 application protocol (F1-AP) message).

As further shown in FIG. 4, the IAB network may include IAB nodes 410 (shown as IAB-node 1, IAB-node 2, and IAB-node 3) that connect to the core network via the IAB donor 405. As shown, an IAB node 410 may include MT functions (also sometimes referred to as UE functions (UEF)) and may include DU functions (also sometimes referred to as access node functions (ANF)). The MT functions of an IAB node 410 (e.g., a child node) may be controlled and/or scheduled by another IAB node 410 (e.g., a parent node of the child node) and/or by an IAB donor 405. The DU functions of an IAB node 410 (e.g., a parent node) may control and/or schedule other IAB nodes 410 (e.g., child nodes of the parent node) and/or UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, and/or schedule communications of IAB nodes 410 and/or UEs 120. A UE 120 may include only MT functions, and not DU functions. That is, communications of a UE 120 may be controlled and/or scheduled by an IAB donor 405 and/or an IAB node 410 (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 405 or an IAB node 410, and a child node may be an IAB node 410 or a UE 120. Communications of an MT function of a child node may be controlled and/or scheduled by a parent node of the child node.

As further shown in FIG. 4, a link between a UE 120 (e.g., which only has MT functions, and not DU functions) and an IAB donor 405, or between a UE 120 and an IAB node 410, may be referred to as an access link 415. Access link 415 may be a wireless access link that provides a UE 120 with radio access to a core network via an IAB donor 405, and optionally via one or more IAB nodes 410. Thus, the network illustrated in 4 may be referred to as a multi-hop network or a wireless multi-hop network.

As further shown in FIG. 4, a link between an IAB donor 405 and an IAB node 410 or between two IAB nodes 410 may be referred to as a backhaul link 420. Backhaul link 420 may be a wireless backhaul link that provides an IAB node 410 with radio access to a core network via an IAB donor 405, and optionally via one or more other IAB nodes 410. In an IAB network, network resources for wireless communications (e.g., time resources, frequency resources, and/or spatial resources) may be shared between access links 415 and backhaul links 420. In some aspects, a backhaul link 420 may be a primary backhaul link or a secondary backhaul link (e.g., a backup backhaul link). In some aspects, a secondary backhaul link may be used if a primary backhaul link fails, becomes congested, and/or becomes overloaded, among other examples. For example, a backup link 425 between IAB-node 2 and IAB-node 3 may be used for backhaul communications if a primary backhaul link between IAB-node 2 and IAB-node 1 fails. As used herein, a node or a wireless node may refer to an IAB donor 405 or an IAB node 410.

In some aspects, the DU of the IAB node 410 may receive, from the CU of the IAB donor 405, an indication of a mobility state of a child node of the DU of the IAB node 410. The DU of the IAB node 410 may perform an admission control for the child node based at least in part on the mobility state of the child node.

In some aspects, the CU of the IAB donor 405 may transmit, to the DU of the IAB donor 405, an indication of a mobility state of a child node of the DU of the IAB node 410. The CU of the IAB donor 405 may receive, from the DU of the IAB node 410, an indication of an admission control that indicates whether the DU of the IAB node 410 admits the child node.

As indicated above, FIG. 4 is provided as an example. Other examples may differ from what is described with regard to FIG. 4.

As described above, in a typical IAB network, IAB nodes (e.g., non-anchor base stations) are stationary (or non-moving). Conversely, in a mobile IAB network, one or more IAB nodes may have capabilities to change locations or otherwise move around in the IAB network. In general, such IAB nodes may be referred to as mobile IAB nodes. For example, a mobile IAB node may be installed on a moving object (e.g., an automobile, a truck, a bus, a train, a taxi, a subway car, a motorcycle, a bicycle, a motorized personal conveyance, an elevator, a cable car, or a robot). Additionally, or alternatively, a mobile IAB node may be provided on an aerial or orbiting device (e.g., an unmanned aerial vehicle or drone, an airplane, a helicopter, a satellite, a dirigible, or a balloon), and/or a marine vessel (e.g., a boat, a ferry, a passenger ship, or a freighter). In a mobile IAB network, there may be a mix of stationary IAB nodes and mobile IAB nodes. In some cases, the mobile IAB nodes may be constrained to be “leaf” nodes in the mobile IAB network. That is, a mobile IAB node may be permitted to be only a last-hop IAB node, with only child access UEs connected to the mobile IAB node. In some other cases, a mobile IAB node may be permitted to have another IAB node as a child node.

In some examples, a mobile IAB node may provide an independently moving cell site. In such a case, a mobile IAB node (e.g., a communication device installed on a moving object, an aerial or orbiting device, and/or a marine vessel) can provide a moving cell site for surrounding served nodes (e.g., a UE located inside and/or outside a vehicle containing a mobile IAB node in an urban area, and/or an MT of a child IAB node). Here, the serving mobile IAB node may move relatively randomly, at relatively low speeds (e.g., at urban city speed), or over a relatively large distance. In this case, the mobility of a given served node may be determined relative to the serving mobile IAB node. For example, in some cases, a served node may move independently from the serving mobile IAB node (e.g., movement of the served node is not predictable from movement of the serving mobile IAB node) even though the movement of the served node may be at a speed similar to the serving mobile IAB node (e.g., a served UE in a vehicle traveling on the same roadway as a serving mobile IAB node).

In some other examples, a mobile IAB node may provide a jointly moving cell site (e.g., on a high-speed train). In such a case, a mobile IAB node may be mounted on the moving cell site (e.g., on top of a high-speed train) in order to serve other nodes on or in the moving cell site (e.g., UEs belonging to users traveling inside the high-speed train). Here, the mobility of the serving mobile IAB node may be predictable, at relatively high speeds, and over a large distance. In this use case, served nodes on or in the moving cell site may move jointly with the serving mobile IAB node (e.g., movement of the served node is generally predictable according to the movement of the serving mobile IAB node).

In some other examples, a mobile IAB node may facilitate a platoon, when, for example, a loose group of nodes served by the mobile IAB node is generally moving together. In such a case, a single IAB node may provide network connectivity for nearby nodes. For example, a mobile IAB node mounted on a first vehicle driving on a freeway may provide network connectivity for UEs and/or MTs of child IAB nodes in the first vehicle as well as UEs and/or MTs of child IAB nodes in other vehicles driving on the freeway in the same direction and at a similar speed. In such cases, the serving mobile IAB node may connect to the network, while other vehicles may be configured to act as respective child nodes. Here, the serving mobile IAB node may move with local predictability, at a relatively constant speed, and over a relatively large distance. Further, the served nodes may move jointly with the mobile IAB node.

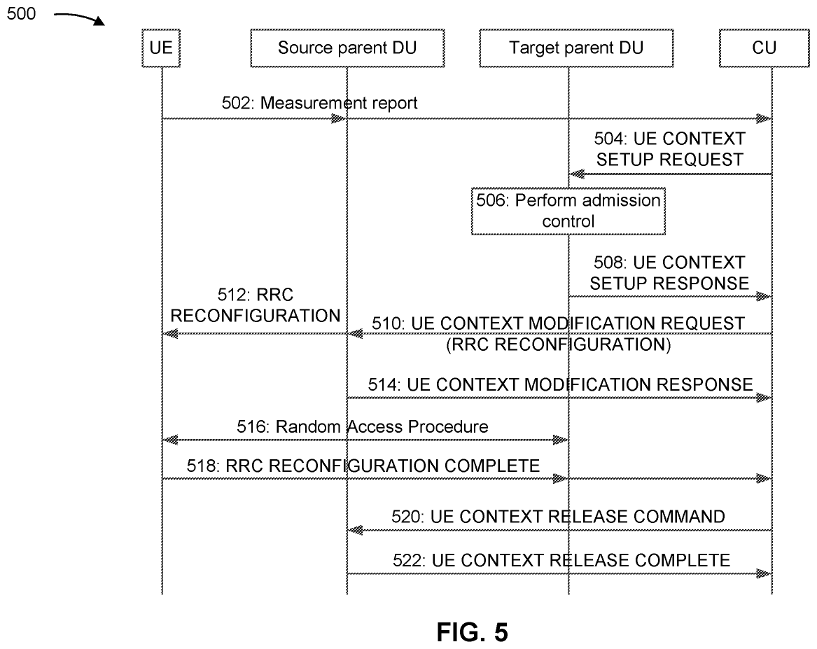

FIG. 5 is a diagram illustrating an example 500 of admission control, in accordance with the present disclosure.

As shown by reference number 502, a UE may transmit a measurement report to a source parent DU, which may forward the measurement report to a CU. As shown by reference number 504, the CU may transmit a UE context setup request to a target parent DU. As shown by reference number 506, the target parent DU may perform an admission control, which may involve the target parent DU determining whether to provide a service to the UE. The target parent DU may perform the admission control depending on an availability of resources. The target parent DU may perform the admission control based at least in part on the UE context setup request, which may indicate the measurement report and/or a UE request (e.g., a QoS service). As shown by reference number 508, the target parent DU may transmit, to the CU, a UE context setup response based at least in part on the admission control. For example, the target parent DU may transmit the UE context setup response based at least in part on a determination to provide the service to the UE. As shown by reference number 510, the CU may transmit an RRC reconfiguration message to the source parent DU. The RRC reconfiguration message may include a UE context modification request that indicates a handover command. As shown by reference number 512, the source parent DU may forward the RRC reconfiguration message to the UE. As shown by reference number 514, the source parent DU may transmit a UE context modification response to the CU. As shown by reference number 516, the UE and the target parent DU may perform a random access procedure. As shown by reference number 518, the UE may transmit an RRC reconfiguration complete message to the target parent DU, which may forward the RRC reconfiguration complete message to the CU. As shown by reference number 520, the CU may transmit a UE context release command to the source parent DU. As shown by reference number 522, the source parent DU may transmit a UE context release complete message to the CU.

In the example shown in FIG. 5, admission control may be associated with handover. Alternatively, admission control may be associated with an initial access, a reestablishment procedure, or a secondary node (SN) or secondary cell group (SCG) addition for a child node.

As indicated above, FIG. 5 is provided as an example. Other examples may differ from what is described with regard to FIG. 5.

A DU of an IAB node (e.g., a first IAB node) may be mobile or stationary. The DU of the IAB node may be associated with a parent node. A child node of the IAB node may also be mobile or stationary. The child node may be a UE, an MT of a second IAB node, or a repeater. For example, the DU may be mobile and the child node may be mobile, the DU may be stationary and the child node may be stationary, the DU may be mobile and the child node may be stationary, or the DU may be stationary and the child node may be mobile. A CU of an IAB donor may transmit a request to the DU of the IAB node, where the request may be to set up a context for the child node to be served by the DU.

The DU may perform an admission control to determine whether the DU should serve the child node. However, the DU may perform the admission control without having information regarding a mobility of the child node. The mobility may indicate a relative mobility, which may correspond to the mobility of the child node in relation to a mobility of the DU. The mobility of the child node may impact whether admitting the child node is favorable or not favorable to the DU. As a result, in some cases, the DU may determine to serve the child node (or admit the child node) even though the mobility of the child node may cause admission of the child node to be unfavorable to the DU. In this case, unfavorable admission may result in an increased likelihood of handovers for the child node and/or poorer connections with lower data rates for the child node. Nevertheless, the child node may be admitted because the DU does not possess the information regarding the mobility of the child node.

Further, although the DU may receive measurements associated with the child node and the DU may use the measurements when performing the admission control, the measurements may not indicate the mobility of the DU. As a result, favorable measurements may cause the DU to admit the child node, even though the mobility of the child node may cause the admission of the child node to be unfavorable to the DU.

In various aspects of techniques and apparatuses described herein, a DU of an IAB node may receive, from a CU of an IAB donor, an indication of a mobility state of a child node of the DU. The child node may be a UE, an MT of another IAB node, or a repeater. The mobility state may indicate a relative mobility of the child node with respect to the DU. The DU may perform an admission control based at least in part on the mobility state of the child node, as indicated by the CU. The DU may determine, based at least in part on the admission control, to serve the child node based at least in part on the mobility state of the child node. Alternatively, the DU may determine, based at least in part on the admission control, to not serve the child node based at least in part on the mobility state of the child node.

As an example, a CU may indicate, to a stationary DU, that a child node is a mobile IAB node. The CU may indicate, to the stationary DU, information regarding a speed, direction of motion, expected time of arrival, etc. of the mobile IAB node. The stationary DU may determine to admit the mobile IAB node based at least in part on a service interruption for the mobile IAB node's child nodes being minimized. As another example, a CU may indicate to a mobile DU, that a child node is a pedestrian UE or a passenger UE. A pedestrian UE may be a UE that is located outside of the mobile DU, whereas a passenger UE may be a UE that travels with the mobile DU. The mobile DU, when performing admission control, may prioritize an admission of a passenger UE over a pedestrian UE, since the pedestrian UE may be associated with an increased likelihood of handovers as compared to the passenger UE that travels along with the mobile DU. In some cases, the DU may admit the pedestrian UE when there is no impact or minimal impact to the passenger UE.

FIG. 6 is a diagram illustrating an example 600 associated with admission control of nodes depending on mobility status, in accordance with the present disclosure. As shown in FIG. 6, example 600 includes communication between a DU of an IAB node (e.g., DU of IAB node 410) and a CU of an IAB donor (e.g., CU of IAB donor 405). Alternatively, the communication may be between a DU of the IAB donor and the CU of the IAB donor. In some aspects, the DU of the IAB node (or the DU of the IAB donor) and the CU of the IAB donor may be included in a wireless network, such as wireless network 100.

As shown by reference number 602, the DU may receive, from the CU, an indication of a mobility state of a child node of the DU. The indication of the mobility status of the child node may indicate a relative mobility of the child node in relation to the DU (or a DU cell associated with the DU). In some cases, the indication of the mobility status of the child node may indicate no relative mobility or minimal relative mobility for the child node (e.g., when the child node moves along with the DU).

In some aspects, the indication of the mobility status of the child node may indicate a classification of the child node. For example, the indication of the mobility status of the child node may indicate whether the child node is a pedestrian UE or a passenger UE, where the pedestrian UE may be located outside of the DU whereas the passenger UE may travel with the DU. The indication of the mobility status of the child node may indicate a level of mobility of the child node (e.g., low, medium, or high), a speed of the child node, a direction of the child node, an expected time of connection to the DU cell associated with the DU, and/or an expected duration of service in the DU cell associated with the DU.

In some aspects, the child node may be a UE. The IAB node may be a first IAB node, and the child node may be an MT of a second IAB node. The child node may be a repeater. In some aspects, the DU may be a mobile DU or a stationary DU. In other words, the DU (or DU cell) and/or the child node may be mobile or stationary.

As shown by reference number 604, the DU may perform an admission control for the child node based at least in part on the mobility statis of the child node. The admission control may involve the DU determining whether to approve providing service to the child node. The DU may, when performing the admission control, admit the child node based at least in part on the mobility status of the child node. Alternatively, the DU may, when performing the admission control, refrain from admitting the child node based at least in part on the mobility status of the child node. In some aspects, the admission control may be associated with admitting the child node for a purpose of serving the child node or for a purpose of providing a service to the child node. As an example, the service may involve providing a data radio bearer for the child node, or providing a backhaul radio link control (RLC) channel setup for the child node.

In some aspects, depending on the mobility status of the child node, the DU may determine whether or not to admit the child node or refrain from admitting the child node. For example, when the mobility status indicates a relative mobility that satisfies a first threshold (e.g., a relative mobility that exceeds the first threshold), the DU may determine to not provide service to the child node because the relative mobility may lead to an increased likelihood of required handovers for the child node. On the other hand, when the mobility status indicates a relative mobility that satisfies a second threshold (e.g., a relative mobility that is less than the second threshold), the DU may determine to provide service to the child node because the relative mobility may result in a relatively stable connection for the child node and may not require a handover of the child node.

As an example, the DU may be associated with a taxi that moves between locations. The child node may be a pedestrian UE. At a point in time, the child node may be located in proximity to the DU (e.g., within a defined range), and the DU may determine whether to provide service to the child node. Since the DU is associated with the moving taxi and is expected to not be in proximity to the child node at a later time, the DU may determine to not admit the child node because the child node is likely to need a handover when the DU moves to another location.

As another example, the DU may be associated with a train that moves along a predefined route. The child node may be a passenger UE. Since the child node is expected to move along with the DU with no or little relative mobility, thereby resulting in a relatively stable connection between the child node and the DU, the DU may determine to admit the child node.

In some aspects, the admission control may associated with an initial access (e.g., an initial access to a network for a UE which may include beam management), a handover (e.g., a handover of a UE from a source parent DU to a target parent DU), a reestablishment (e.g., reestablishing an RRC connection for a UE), or a secondary node or a secondary cell group addition for the child node.

As shown by reference number 606, the DU may transmit, to the CU and based at least in part on the admission control, an indication of the admission control that indicates whether the DU admits the child node. In some aspects, the indication of the admission control may be one bit, where a first bit value may indicate that the DU admits the child node and a second bit value may indicate that the DU does not admit the child node. In some aspects, the indication of the admission control may be one or more bits, where a first bit value indicates a first service to be provided to the child node, a second bit value indicates a second service to be provided to the child node, and so on.

In some aspects, the CU may receive the indication of the mobility status of the child node from another node, such as a second CU or an AMF. In some cases, the CU may receive the indication of the mobility status of the child node from the child node. The CU may forward the indication of the mobility status of the child node to the DU.

In some aspects, the indication of the mobility state of the child node may be received in a UE context setup request message or in a UE context modification request message. In some aspects, the indication of the admission control may be transmitted in a UE context setup response message or in a UE context modification response message.

As indicated above, FIG. 6 is provided as an example. Other examples may differ from what is described with regard to FIG. 6.

FIG. 7 is a diagram illustrating an example process 700 performed, for example, by a DU of an IAB node, in accordance with the present disclosure. Example process 700 is an example where the DU of the IAB node (e.g., DU of IAB node 410) performs operations associated with admission control of nodes depending on mobility status.

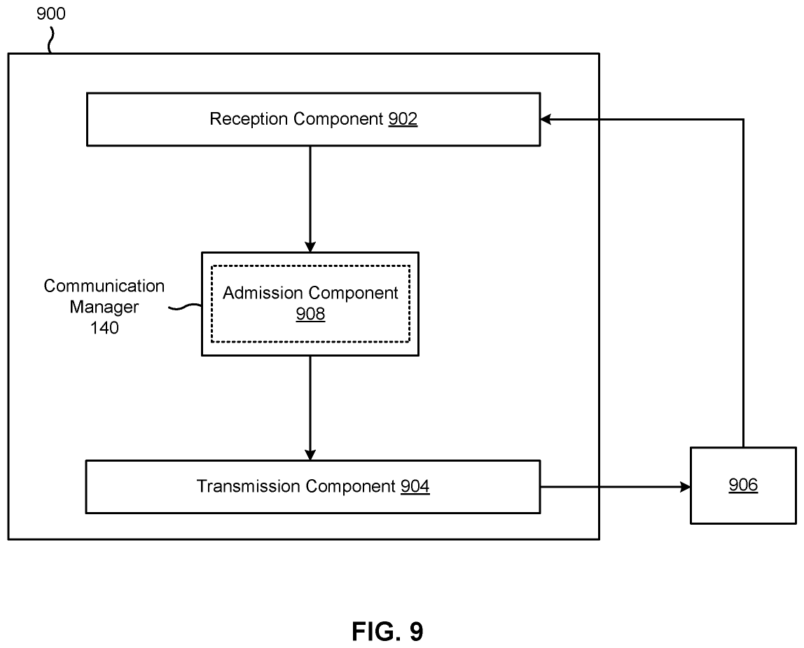

As shown in FIG. 7, in some aspects, process 700 may include receiving, from a CU of an IAB donor, an indication of a mobility state of a child node of the DU (block 710). For example, the DU (e.g., using communication manager 140 and/or reception component 902, depicted in FIG. 9) may receive, from a CU of an IAB donor, an indication of a mobility state of a child node of the DU, as described above.

As further shown in FIG. 7, in some aspects, process 700 may include performing an admission control for the child node based at least in part on the mobility state of the child node (block 720). For example, the DU (e.g., using communication manager 140 and/or admission component 908, depicted in FIG. 9) may perform an admission control for the child node based at least in part on the mobility state of the child node, as described above.

Process 700 may include additional aspects, such as any single aspect or any combination of aspects described below and/or in connection with one or more other processes described elsewhere herein.

In a first aspect, process 700 includes admitting the child node based at least in part on the mobility state of the child node.

In a second aspect, alone or in combination with the first aspect, process 700 includes refraining from admitting the child node based at least in part on the mobility state of the child node.

In a third aspect, alone or in combination with one or more of the first and second aspects, process 700 includes transmitting, to the CU and based at least in part on the admission control, an indication of the admission control that indicates whether the DU admits the child node.

In a fourth aspect, alone or in combination with one or more of the first through third aspects, the indication of the mobility state of the child node is received in a UE context setup request message or in a UE context modification request message, and wherein the indication of the admission control is transmitted in a UE context setup response message or in a UE context modification response message.

In a fifth aspect, alone or in combination with one or more of the first through fourth aspects, the IAB node is a first IAB node, and the child node is one of a UE, an MT of a second IAB node, or a repeater.

In a sixth aspect, alone or in combination with one or more of the first through fifth aspects, the DU is a mobile DU or a stationary DU.

In a seventh aspect, alone or in combination with one or more of the first through sixth aspects, the indication of the mobility state indicates a relative mobility of the child node in relation to the DU.

In an eighth aspect, alone or in combination with one or more of the first through seventh aspects, the admission control is associated with one of an initial access, a handover, a reestablishment, or a secondary node or a secondary cell group addition for the child node.

In a ninth aspect, alone or in combination with one or more of the first through eighth aspects, the indication of the mobility state of the child node indicates whether the child node is a pedestrian UE or a passenger UE.

In a tenth aspect, alone or in combination with one or more of the first through ninth aspects, the indication of the mobility state of the child node indicates one or more of a level of mobility of the child node, a speed of the child node, a direction of the child node, a location of the child node, an expected time of connection to a DU cell associated with the DU, or an expected duration of service in the DU cell associated with the DU.

In an eleventh aspect, alone or in combination with one or more of the first through tenth aspects, the admission control is associated with admitting the child node for a purpose of serving the child node or providing a service to the child node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a CU of an IAB donor, in accordance with the present disclosure. Example process 800 is an example where the CU of the IAB donor (e.g., CU of IAB donor 405) performs operations associated with admission control of nodes depending on mobility status.

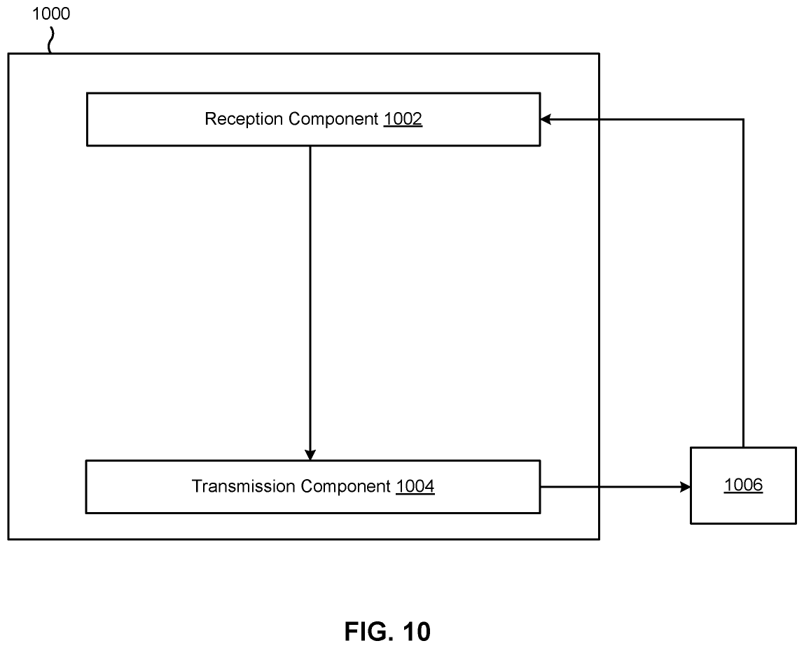

As shown in FIG. 8, in some aspects, process 800 may include transmitting, to a DU of an IAB node, an indication of a mobility state of a child node of the DU (block 810). For example, the CU (e.g., using transmission component 1004, depicted in FIG. 10) may transmit, to a DU of an IAB node, an indication of a mobility state of a child node of the DU, as described above.

As further shown in FIG. 8, in some aspects, process 800 may include receiving, from the DU, an indication of an admission control that indicates whether the DU admits the child node (block 820). For example, the CU (e.g., using reception component 1002, depicted in FIG. 10) may receive, from the DU, an indication of an admission control that indicates whether the DU admits the child node, as described above.

Process 800 may include additional aspects, such as any single aspect or any combination of aspects described below and/or in connection with one or more other processes described elsewhere herein.

In a first aspect, process 800 includes receiving the indication of the mobility state of the child node from another node, wherein the indication of the mobility state of the child node is forwarded to the DU.

In a second aspect, alone or in combination with the first aspect, the indication of the mobility state of the child node is transmitted in a UE context setup request message or in a UE context modification request message, and wherein the indication of the admission control is received in a UE context setup response message or in a UE context modification response message.

In a third aspect, alone or in combination with one or more of the first and second aspects, the IAB node is a first IAB node, and the child node is one of a UE, a mobile termination of a second IAB node, or a repeater.

In a fourth aspect, alone or in combination with one or more of the first through third aspects, the DU is a mobile DU or a stationary DU.

In a fifth aspect, alone or in combination with one or more of the first through fourth aspects, the indication of the mobility state indicates a relative mobility of the child node in relation to the DU.

In a sixth aspect, alone or in combination with one or more of the first through fifth aspects, the admission control is associated with one of an initial access, a handover, a reestablishment, or a secondary node or a secondary cell group addition for the child node.

In a seventh aspect, alone or in combination with one or more of the first through sixth aspects, the indication of the mobility state of the child node indicates whether the child node is a pedestrian UE or a passenger UE.

In an eighth aspect, alone or in combination with one or more of the first through seventh aspects, the indication of the mobility state of the child node indicates one or more of a level of mobility of the child node, a speed of the child node, a direction of the child node, a location of the child node, an expected time of connection to a DU cell associated with the DU, or an expected duration of service in the DU cell associated with the DU.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a DU of an IAB node, or a DU of an IAB node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include an admission component 908, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the DU of the IAB node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the DU of the IAB node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the DU of the IAB node described in connection with FIG. 2. In some aspects, the transmission component 904 may be co-located with the reception component 902 in a transceiver.

The reception component 902 may receive, from a CU of an IAB donor, an indication of a mobility state of a child node of the DU. The admission component 908 may perform an admission control for the child node based at least in part on the mobility state of the child node. The admission component 908 may admit the child node based at least in part on the mobility state of the child node. The admission component 908 may refrain from admitting the child node based at least in part on the mobility state of the child node. The transmission component 904 may transmit, to the CU and based at least in part on the admission control, an indication of the admission control that indicates whether the DU admits the child node.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a CU of an IAB donor, or a CU of an IAB donor may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the CU of the IAB donor described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the CU of the IAB donor described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the CU of the IAB donor described in connection with FIG. 2. In some aspects, the transmission component 1004 may be co-located with the reception component 1002 in a transceiver.

The transmission component 1004 may transmit, to a DU of an IAB node, an indication of a mobility state of a child node of the DU. The reception component 1002 may receive, from the DU, an indication of an admission control that indicates whether the DU admits the child node. The reception component 1002 may receive the indication of the mobility state of the child node from another node, wherein the indication of the mobility state of the child node is forwarded to the DU.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram illustrating an example 1100 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 11 may include one or more CUs 1110 that can communicate directly with a core network 1120 via a backhaul link, or indirectly with the core network 1120 through one or more disaggregated base station units (such as a Near-Real Time (Near-RT) RAN Intelligent Controller (MC) 1125 via an E2 link, or a Non-Real Time (Non-RT) MC 1115 associated with a Service Management and Orchestration (SMO) Framework 1105, or both). A CU 1110 may communicate with one or more DUs 1130 via respective midhaul links, such as an F1 interface. The DUs 1130 may communicate with one or more RUs 1140 via respective fronthaul links. The RUs 1140 may communicate with respective UEs 120 via one or more radio frequency (RF) access links. In some implementations, the UE 120 may be simultaneously served by multiple RUs 1140.

Each of the units (e.g., the CUs 1110, the DUs 1130, the RUs 1140), as well as the Near-RT RICs 1125, the Non-RT RICs 1115, and the SMO Framework 1105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 1110 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 1110. The CU 1110 may be configured to handle user plane functionality (e.g., Central Unit-User Plane (CU-UP)), control plane functionality (e.g., Central Unit-Control Plane (CU-CP)), or a combination thereof. In some implementations, the CU 1110 can be logically split into one or more CU-UP units and one or more CU-CP units. The CU-UP unit can communicate bidirectionally with the CU-CP unit via an interface, such as the E1 interface when implemented in an O-RAN configuration. The CU 1110 can be implemented to communicate with the DU 1130, as necessary, for network control and signaling.

The DU 1130 may correspond to a logical unit that includes one or more base station functions to control the operation of one or more RUs 1140. In some aspects, the DU 1130 may host one or more of an RLC layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 1130 may further host one or more low-PHY layers. Each layer (or module) can be implemented with an interface configured to communicate signals with other layers (and modules) hosted by the DU 1130, or with the control functions hosted by the CU 1110.

Lower-layer functionality can be implemented by one or more RUs 1140. In some deployments, an RU 1140, controlled by a DU 1130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1140 can be implemented to handle over the air (OTA) communication with one or more UEs 120. In some implementations, real-time and non-real-time aspects of control and user plane communication with the RU(s) 1140 can be controlled by the corresponding DU 1130. In some scenarios, this configuration can enable the DU(s) 1130 and the CU 1110 to be implemented in a cloud-based RAN architecture, such as a vRAN architecture.

The SMO Framework 1105 may be configured to support RAN deployment and provisioning of non-virtualized and virtualized network elements. For non-virtualized network elements, the SMO Framework 1105 may be configured to support the deployment of dedicated physical resources for RAN coverage requirements which may be managed via an operations and maintenance interface (such as an O1 interface). For virtualized network elements, the SMO Framework 1105 may be configured to interact with a cloud computing platform (such as an open cloud (O-Cloud) 1190) to perform network element life cycle management (such as to instantiate virtualized network elements) via a cloud computing platform interface (such as an O2 interface). Such virtualized network elements can include, but are not limited to, CUs 1110, DUs 1130, RUs 1140 and Near-RT RICs 1125. In some implementations, the SMO Framework 1105 can communicate with a hardware aspect of a 4G RAN, such as an open eNB (O-eNB) 1111, via an O1 interface. Additionally, in some implementations, the SMO Framework 1105 can communicate directly with one or more RUs 1140 via an O1 interface. The SMO Framework 1105 also may include a Non-RT RIC 1115 configured to support functionality of the SMO Framework 1105.

The Non-RT RIC 1115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1125. The Non-RT RIC 1115 may be coupled to or communicate with (such as via an A1 interface) the Near-RT RIC 1125. The Near-RT RIC 1125 may be configured to include a logical function that enables near-real-time control and optimization of RAN elements and resources via data collection and actions over an interface (such as via an E2 interface) connecting one or more CUs 1110, one or more DUs 1130, or both, as well as an O-eNB, with the Near-RT RIC 1125.

In some implementations, to generate AI/ML models to be deployed in the Near-RT RIC 1125, the Non-RT RIC 1115 may receive parameters or external enrichment information from external servers. Such information may be utilized by the Near-RT RIC 1125 and may be received at the SMO Framework 1105 or the Non-RT RIC 1115 from non-network data sources or from network functions. In some examples, the Non-RT RIC 1115 or the Near-RT RIC 1125 may be configured to tune RAN behavior or performance. For example, the Non-RT RIC 1115 may monitor long-term trends and patterns for performance and employ AI/ML models to perform corrective actions through the SMO Framework 1105 (such as reconfiguration via 01) or via creation of RAN management policies (such as A1 policies).

As indicated above, FIG. 11 is provided as an example. Other examples may differ from what is described with regard to FIG. 11.

The following provides an overview of some Aspects of the present disclosure:

Aspect 1: A method of wireless communication performed by a distributed unit (DU) of an integrated access and backhaul (IAB) node, comprising: receiving, from a centralized unit (CU) of an IAB donor, an indication of a mobility state of a child node of the DU; and performing an admission control for the child node based at least in part on the mobility state of the child node.

Aspect 2: The method of Aspect 1, wherein performing the admission control comprises admitting the child node based at least in part on the mobility state of the child node.

Aspect 3: The method of any of Aspects 1 through 2, wherein performing the admission control comprises refraining from admitting the child node based at least in part on the mobility state of the child node.

Aspect 4: The method of any of Aspects 1 through 3, further comprising: transmitting, to the CU and based at least in part on the admission control, an indication of the admission control that indicates whether the DU admits the child node.

Aspect 5: The method of Aspect 4, wherein the indication of the mobility state of the child node is received in a UE context setup request message or in a UE context modification request message, and wherein the indication of the admission control is transmitted in a UE context setup response message or in a UE context modification response message.

Aspect 6: The method of any of Aspects 1 through 5, wherein the IAB node is a first IAB node, and wherein the child node is one of a user equipment, a mobile termination of a second IAB node, or a repeater.

Aspect 7: The method of any of Aspects 1 through 6, wherein the DU is a mobile DU or a stationary DU.

Aspect 8: The method of any of Aspects 1 through 7, wherein the indication of the mobility state indicates a relative mobility of the child node in relation to the DU.

Aspect 9: The method of any of Aspects 1 through 8, wherein the admission control is associated with one of: an initial access, a handover, a reestablishment, or a secondary node or a secondary cell group addition for the child node.

Aspect 10: The method of any of Aspects 1 through 9, wherein the indication of the mobility state of the child node indicates whether the child node is a pedestrian user equipment (UE) or a passenger UE.

Aspect 11: The method of any of Aspects 1 through 10, wherein the indication of the mobility state of the child node indicates one or more of: a level of mobility of the child node, a speed of the child node, a direction of the child node, a location of the child node, an expected time of connection to a DU cell associated with the DU, or an expected duration of service in the DU cell associated with the DU.

Aspect 12: The method of any of Aspects 1 through 11, wherein the admission control is associated with admitting the child node for a purpose of serving the child node or providing a service to the child node.

Aspect 13: A method of wireless communication performed by a centralized unit (CU) of an integrated access and backhaul (IAB) donor, comprising: transmitting, to a distributed unit (DU) of an IAB node, an indication of a mobility state of a child node of the DU; and receiving, from the DU, an indication of an admission control that indicates whether the DU admits the child node.

Aspect 14: The method of Aspect 13, further comprising: receiving the indication of the mobility state of the child node from another node, wherein the indication of the mobility state of the child node is forwarded to the DU.

Aspect 15: The method of Aspect 14, wherein the indication of the mobility state of the child node is transmitted in a UE context setup request message or in a UE context modification request message, and wherein the indication of the admission control is received in a UE context setup response message or in a UE context modification response message.

Aspect 16: The method of any of Aspects 13 through 15, wherein the IAB node is a first IAB node, and wherein the child node is one of a user equipment, a mobile termination of a second IAB node, or a repeater.

Aspect 17: The method of any of Aspects 13 through 16, wherein the DU is a mobile DU or a stationary DU.

Aspect 18: The method of any of Aspects 13 through 17, wherein the indication of the mobility state indicates a relative mobility of the child node in relation to the DU.

Aspect 19: The method of any of Aspects 13 through 18, wherein the admission control is associated with one of: an initial access, a handover, a reestablishment, or a secondary node or a secondary cell group addition for the child node.

Aspect 20: The method of any of Aspects 13 through 19, wherein the indication of the mobility state of the child node indicates whether the child node is a pedestrian user equipment (UE) or a passenger UE.

Aspect 21: The method of any of Aspects 13 through 20, wherein the indication of the mobility state of the child node indicates one or more of: a level of mobility of the child node, a speed of the child node, a direction of the child node, a location of the child node, an expected time of connection to a DU cell associated with the DU, or an expected duration of service in the DU cell associated with the DU.

Aspect 22: An apparatus for wireless communication at a device, comprising a processor; memory coupled with the processor; and instructions stored in the memory and executable by the processor to cause the apparatus to perform the method of one or more of Aspects 1-12.

Aspect 23: A device for wireless communication, comprising a memory and one or more processors coupled to the memory, the one or more processors configured to perform the method of one or more of Aspects 1-12.

Aspect 24: An apparatus for wireless communication, comprising at least one means for performing the method of one or more of Aspects 1-12.

Aspect 25: A non-transitory computer-readable medium storing code for wireless communication, the code comprising instructions executable by a processor to perform the method of one or more of Aspects 1-12.

Aspect 26: A non-transitory computer-readable medium storing a set of instructions for wireless communication, the set of instructions comprising one or more instructions that, when executed by one or more processors of a device, cause the device to perform the method of one or more of Aspects 1-12.

Aspect 27: An apparatus for wireless communication at a device, comprising a processor; memory coupled with the processor; and instructions stored in the memory and executable by the processor to cause the apparatus to perform the method of one or more of Aspects 13-21.

Aspect 28: A device for wireless communication, comprising a memory and one or more processors coupled to the memory, the one or more processors configured to perform the method of one or more of Aspects 13-21.

Aspect 29: An apparatus for wireless communication, comprising at least one means for performing the method of one or more of Aspects 13-21.

Aspect 30: A non-transitory computer-readable medium storing code for wireless communication, the code comprising instructions executable by a processor to perform the method of one or more of Aspects 13-21.

Aspect 31: A non-transitory computer-readable medium storing a set of instructions for wireless communication, the set of instructions comprising one or more instructions that, when executed by one or more processors of a device, cause the device to perform the method of one or more of Aspects 13-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus of a distributed unit (DU) of an integrated access and backhaul (IAB) node for wireless communication, comprising:
a memory; and
one or more processors coupled to the memory, wherein the memory includes instructions executable by the one or more processors to cause the DU of the IAB node to:
receive, from a centralized unit (CU) of an IAB donor, an indication of a mobility state of a child node of the DU; and
perform an admission control for the child node based at least in part on the mobility state of the child node.

2. The apparatus of claim 1, wherein the instructions executable by the one or more processors, to perform the admission control, cause the DU of the IAB node to:
admit the child node based at least in part on the mobility state of the child node.

3. The apparatus of claim 1, wherein the instructions executable by the one or more processors, to perform the admission control, cause the DU of the IAB node to:
refrain from admitting the child node based at least in part on the mobility state of the child node.

4. The apparatus of claim 1, wherein the instructions executable by the one or more processors cause the DU of the IAB node to:
transmit, to the CU and based at least in part on the admission control, an indication of the admission control that indicates whether the DU admits the child node.

5. The apparatus of claim 4, wherein the indication of the mobility state of the child node is received in a UE context setup request message or in a UE context modification request message, and wherein the indication of the admission control is transmitted in a UE context setup response message or in a UE context modification response message.

6. The apparatus of claim 1, wherein the IAB node is a first IAB node, and wherein the child node is one of a user equipment, a mobile termination of a second IAB node, or a repeater.

7. The apparatus of claim 1, wherein the DU is a mobile DU or a stationary DU.

8. The apparatus of claim 1, wherein the indication of the mobility state indicates a relative mobility of the child node in relation to the DU.

9. The apparatus of claim 1, wherein the admission control is associated with one of: an initial access, a handover, a reestablishment, or a secondary node or a secondary cell group addition for the child node.

10. The apparatus of claim 1, wherein the indication of the mobility state of the child node indicates whether the child node is a pedestrian user equipment (UE) or a passenger UE.

11. The apparatus of claim 1, wherein the indication of the mobility state of the child node indicates one or more of: a level of mobility of the child node, a speed of the child node, a direction of the child node, a location of the child node, an expected time of connection to a DU cell associated with the DU, or an expected duration of service in the DU cell associated with the DU.

12. The apparatus of claim 1, wherein the admission control is associated with admitting the child node for a purpose of serving the child node or providing a service to the child node.

13. An apparatus of a centralized unit (CU) of an integrated access and backhaul (IAB) donor for wireless communication, comprising:
a memory; and
one or more processors coupled to the memory, wherein the memory includes instructions executable by the one or more processors to cause the CU of the IAB donor to:
transmit, to a distributed unit (DU) of an IAB node, an indication of a mobility state of a child node of the DU; and
receive, from the DU, an indication of an admission control that indicates whether the DU admits the child node.

14. The apparatus of claim 13, wherein the instructions executable by the one or more processors cause the CU of the IAB donor to:
receive the indication of the mobility state of the child node from another node, wherein the indication of the mobility state of the child node is forwarded to the DU.

15. The apparatus of claim 14, wherein the indication of the mobility state of the child node is transmitted in a UE context setup request message or in a UE context modification request message, and wherein the indication of the admission control is received in a UE context setup response message or in a UE context modification response message.

16. The apparatus of claim 13, wherein the IAB node is a first IAB node, and wherein the child node is one of a user equipment, a mobile termination of a second IAB node, or a repeater.

17. The apparatus of claim 13, wherein the DU is a mobile DU or a stationary DU.

18. The apparatus of claim 13, wherein the indication of the mobility state indicates a relative mobility of the child node in relation to the DU.

19. The apparatus of claim 13, wherein the admission control is associated with one of: an initial access, a handover, a reestablishment, or a secondary node or a secondary cell group addition for the child node.

20. The apparatus of claim 13, wherein the indication of the mobility state of the child node indicates whether the child node is a pedestrian user equipment (UE) or a passenger UE.

21. The apparatus of claim 13, wherein the indication of the mobility state of the child node indicates one or more of: a level of mobility of the child node, a speed of the child node, a direction of the child node, a location of the child node, an expected time of connection to a DU cell associated with the DU, or an expected duration of service in the DU cell associated with the DU.

22. A method of wireless communication performed by a distributed unit (DU) of an integrated access and backhaul (IAB) node, comprising:
receiving, from a centralized unit (CU) of an IAB donor, an indication of a mobility state of a child node of the DU; and
performing an admission control for the child node based at least in part on the mobility state of the child node.

23. The method of claim 22, wherein performing the admission control comprises:
admitting the child node based at least in part on the mobility state of the child node; or
refraining from admitting the child node based at least in part on the mobility state of the child node.

24. The method of claim 22, further comprising:
transmitting, to the CU and based at least in part on the admission control, an indication of the admission control that indicates whether the DU admits the child node.

25. The method of claim 22, wherein the IAB node is a first IAB node, and wherein the child node is one of a user equipment, a mobile termination of a second IAB node, or a repeater.

26. The method of claim 22, wherein the DU is a mobile DU or a stationary DU.

27. The method of claim 22, wherein the indication of the mobility state indicates a relative mobility of the child node in relation to the DU.

28. A method of wireless communication performed by a centralized unit (CU) of an integrated access and backhaul (IAB) donor, comprising:
transmitting, to a distributed unit (DU) of an IAB node, an indication of a mobility state of a child node of the DU; and
receiving, from the DU, an indication of an admission control that indicates whether the DU admits the child node.

29. The method of claim 28, further comprising:
receiving the indication of the mobility state of the child node from another node, wherein the indication of the mobility state of the child node is forwarded to the DU.

30. The method of claim 28, wherein the indication of the mobility state indicates a relative mobility of the child node in relation to the DU.
